(19) United States
(12) Patent Application Publication
(10) Pub. No.: US 2014/0369413 A1
(43) Pub. Date: Dec. 18, 2014

(54) SYSTEMS AND METHODS FOR COMPRESSING VIDEO DATA USING IMAGE BLOCK MATCHING

(71) Applicant: VMware, Inc., Palo Alto, CA (US)

(72) Inventor: Jonathan CLARK, San Francisco, CA (US)

(21) Appl. No.: 13/921,017

(22) Filed: Jun. 18, 2013

(51) Int. Cl. H04N 19/583

(52) U.S. Cl. CPC H04N 19/00733
USPC 375/240.16; 375/240.24

(57) ABSTRACT

Systems and methods described herein compress video data using image block matching. A server is configured to access a reference frame of an image in a video, separate the reference frame into a plurality of reference blocks of pixels, calculate a hash value for each of the plurality of reference blocks of pixels, receive a current frame of an image in the video, separate the current frame into a plurality of current blocks of pixels, and calculate a hash value for each of the plurality of current blocks of pixels. Further, the server is configured to compare the reference frame hash values with the current frame hash values, identify a hash value in the reference frame that matches a hash value in the current frame, and store the indication that the hash value in the reference frame matches the hash value in the current frame.

### BACKGROUND

Block matching is a common approach adopted for the purpose of motion estimation for video or video data compression, whose aim is to reduce temporal redundancy in video sequences. The primary goal of a block matching algorithm is to find blocks of pixels in a current frame of video that matches blocks of pixels in past or future frames of video. This can be used to discover temporal redundancy in the video sequence and increase the effectiveness of interframe video compression. When an exact or partial match is found, the matching block of pixels can be transmitted using a motion vector which represents an offset in time and distance from a current block being analyzed. This method enables significant storage and bandwidth savings and, thus, reduces the size of video content.

Some known systems use a brute force approach to search for matching blocks of pixels. The brute force approach for block matching relies on comparing a reference block with all possible candidate blocks belonging to a corresponding search area by computing a “distance” between blocks. The term, “distance” in this context refers to the extent of differences in pixel color values between two candidate blocks. Two pixel blocks that are “close” to each other, may be indistinguishable or nearly indistinguishable despite slight variations in color values of constituent pixels, whereas pixel blocks that are far apart will not appear similar. The most commonly used distance evaluation is the Sum of Absolute Differences (SAD). Once the distances between the reference block and the candidate blocks have been computed, the best matching block is selected as the one corresponding to the minimum distance value found within the search area. However, using of the brute force approach can be expensive to execute in real-time. For example, for each pixel offset on a screen, a 16 pixel by 16 pixel block or square search window is moved over the entire screen and compared against a current block or square being encoded. For a 1028 pixel by 1024 pixel sized screen, 1.7 quadrillion pixel comparison operations may be required. As such, most research to accelerate block search has focused on finding in-exact matches using a threshold SAD and various gradient based descent search algorithms to limit pixel comparisons. Other algorithms attempt to improve performance by limiting the search for pixel changes in a small region around a search point (e.g., an 8 pixel by 8 pixel region). However, reducing the search area in order to save computations does not guarantee finding, for each block, the candidate block at the globally minimum distance within the search area. As a result, a distortion of the compressed video signal tends to increase. In addition, using such a small region makes it challenging to find matches for fast moving content where blocks of pixels move more than 8 pixels between frames.

Accordingly, there is a need for a block search algorithm that performs an equivalent of a full screen exact block search that is substantially faster than current block search algorithms. In addition, there is a need for a block search algorithm that works well on desktop content where gradient based descent does not work.

### BRIEF DESCRIPTION

Systems and methods described herein compress video data using image block matching that utilizes a full screen exact block search. A client is in communication with a server that is configured to access a reference frame of an image in a video, separate the reference frame into a plurality of reference blocks of pixels, and calculate a hash value for each of the reference blocks of pixels. Also, the server is configured to receive a current frame of an image in the video, separate the current frame into a plurality of current blocks of pixels, and calculate a hash value for each of the current blocks of pixels. Further, the server is configured to compare the hash values associated with the reference frame with the hash values associated with the current frame. The server is also configured to identify a hash value in the reference frame that matches a hash value in the current frame, and store the indication that the hash value in the reference frame matches the hash value in the current frame.

### BRIEF DESCRIPTION OF THE DRAWINGS

FIG. 1 is an exemplary system having a web server in communication with a web client.

FIG. 2 is a swimlane diagram of an exemplary method for compressing a video using image block matching.

### DETAILED DESCRIPTION

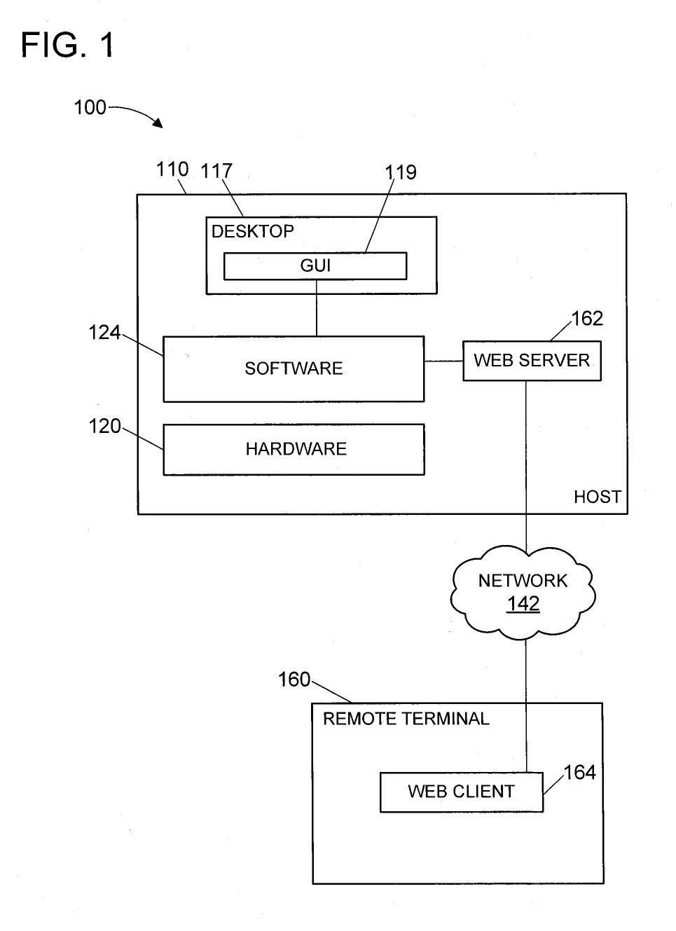

FIG. 1 shows an exemplary system 100 that includes a physical computer system or host 110. Host 110 includes hardware 120 and software 124 running on the hardware 120 such that various applications may be executing on hardware 120 by way of software 124. Software 124 may comprise instructions residing on a memory device (not shown) or other machine readable medium or be implemented directly in hardware 120, e.g., as a system-on-a-chip, firmware, FPGA, etc. Hardware 120 may include at least one processor (not shown), wherein each processor is an execution unit, or “core,” on a microprocessor chip. Hardware 120 may also include devices such as a network interface (NIC), and other devices (not shown) typically associated with computing systems.

In the exemplary embodiment, an end user may connect to, and interact with, host 110 using a remote terminal 160 that is capable of communicating with host 110 via a network 142, which may be the Internet, a LAN, a WAN, or any combination thereof. Remote terminal 160 may be a desktop computer, laptop, mobile device, thin client, or other similar device. Remote terminal 160 is capable of displaying a graphical user interface (GUI) generated by one or more applications running inside host 110. Remote terminal 160 may present the GUI to the end user using a computer display (not shown) or similar device. Remote terminal 160 is also capable of receiving user input from the end user and transmitting the received user input to host 110.

Host 110 provides at least one desktop 117 (only one being shown in FIG. 1) to a user of host 110. The term, “desktop” refers to an interactive user interface, typically implemented using a graphical user interface that displays application and operating system output to a user and accepts mouse and keyboard inputs. In a virtual desktop infrastructure (VDI) deployment, each desktop 117 may be generated by a corresponding virtual machine. A typical VDI deployment may have tens or hundreds of virtual machines distributed across many physical hosts exporting desktops to as many users in disparate remote locations. As mentioned, desktop 117 is an interactive user environment provided by the applications and an operating system (not separately shown) running on host 110, and that includes a graphical user interface (GUI) 119 that may be spread across one or more screens or displays (not shown), but may include other outputs, such as audio, indicator lamps, tactile feedback, etc. It should be noted that while the GUI is generated by software 124 running in host 110, there may not be any display viewable by a user at that location. For example, in a VDI deployment, each host may reside on a rack with many other hosts none of which are connected to an external display. Desktop 117 may receive user inputs from remote terminal 160 over network 142, such as keyboard and mouse inputs, which are injected into desktop 117 in an appropriate way, e.g., using an agent (not shown). In addition to user input/output, desktop 117 may send and receive device data, such as input/output for a FLASH memory device local to the user, or to a local printer. In the exemplary embodiment, GUI 119 may be presented to an end user on the computer display of remote terminal 160.

In the exemplary embodiment, host 110 also includes a server component (e.g., web server 162) that is in communication with software 124. Web server 162 is also in communication with remote terminal 160 and a client (e.g., web client 164) via network 142. In some implementations, web server 162 may also be implemented on a stand-alone server (not shown). Web client 164, in the exemplary embodiment, is a web browser that is configured to run on remote terminal 160 and connects to web server 162 as necessary.

System 100 may be implemented on a physical desktop computer system, such as a work or home computer that is remotely accessed when travelling. Alternatively, system 100 may be implemented on a virtual desktop infrastructure (VDI) as described above that has a plurality of virtual machines (VMs) (not shown) on host 110. In the latter case, software 124 may be virtualization software and one or more VMs (not shown) may be executing on hardware 120 by way of the virtualization software. It should therefore be understood that the present invention can be implemented in a variety of contexts, but may be particularly useful wherever graphical user interface display remoting is implemented.

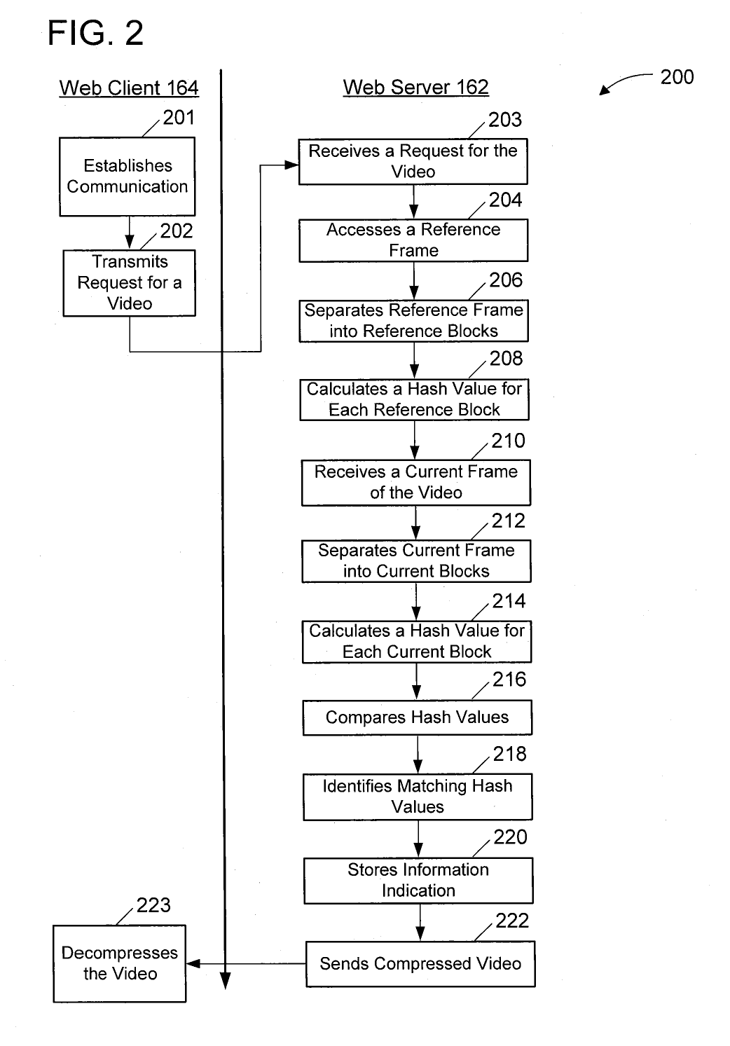

During operation of system 100, as explained in more detail below with respect to FIG. 2, a video is compressed in a preferred manner prior to the transmission of the video from web server 162 to web client 164. It should be recognized that, while the description below references implementation using a web server and a web client (browser), other server-client implementations are possible and are contemplated. In general, upon receiving a web request that corresponds to a request for a video from web client 164, web server 162 encodes updates to GUI 119 into a video stream. That is, prior to transmitting the video to web client 164, web server 162 compresses the video. More specifically, web server 162 compresses the video using image block matching that utilizes a full screen exact block search.

For example, web server 162 performs an equivalent of a full screen exact block matching by matching hash values between blocks of pixels on a current frame of a video and blocks of pixels in a previous frame of the video. Using this approach, image block matches can be robustly found for desktop based content orders of magnitude faster than current systems and methods. To illustrate this further, a full-screen exhaustive block search is capable of being performed in 1 millisecond of central processing unit time. In contrast, H264/MPEG-4 Part 10 or Advanced Video Coding (best known as being one of the codec standards for Blu-Ray™) takes 10-20 times more time and produces worse results than the full-screen exhaustive block search.

In the embodiments described herein, a block of pixels has dimensions that are a power of two (e.g., 2, 4, 8, 16, 32) for each dimension. In the following example, a block of pixels has a dimension of 16 pixels by 16 pixels and each block of pixels is associated with a particular pixel offset. Therefore, to determine which pixels (besides a particular pixel offset) are also included in a particular block of pixels, a block of pixels may be defined as including pixels to the right and below the pixel offset. For example, a hash for pixel offset x=4, y=5 is calculated using pixel values of a 16 pixel by 16 pixel block to the right and below the pixel offset, as shown in Table 1 below:

TABLE 1

| | | | | |
|---|---|---|---|---|
| (4, 5) | (5, 5) | (6, 5) | . . . | (4 + 15, 5) |
| (4, 6) | (5, 6) | (6, 6) | . . . | (4 + 15, 6) |
| . | . | . | . . . | . |
| . | . | . | . . . | . |
| . . . | . . . | . . . | . . . | . . . |
| (4, 5 + 15) | (5, 5 + 15) | (6, 5 + 15) | . . . | (4 + 15, 5 + 15) |

This results in 1280×1024 different hash values for a reference frame, wherein each hash is being formed by the contents of the 16 pixel by 16 pixel block at different offsets on the screen.

In one embodiment, web server 162 calculates a set of hash values for a current frame at block offsets. With this approach, the number of hashes needed to be calculated and compared are significantly reduced. For example, the total number of hashes to be calculated for a frame using block offsets can be determined by dividing the number of pixels in a frame by the number of pixels in a block. Thus, if a frame is 1280 pixels by 1024 pixels and each block is 16 pixels by 16 pixels, the frame size of 1280 pixels by 1024 pixels is divided by the block size of 16 pixels by 16 pixels, which equals 5120. Therefore, only 5120 hashes need to be calculated and compared for a full screen search. The cost savings of only comparing 5120 hash values is significant when compared to current full screen search algorithms that can make up to 1.7 quadrillion pixel comparison operations. In one embodiment, to further reduce latency and processing time, system 100 includes a plurality of processors that calculate the hash values for each or some number of the plurality of reference blocks in parallel. In addition, to minimize latency of a search when it becomes available, the hash values for the reference frames are calculated before the current frame is available.

After web server 162 calculates hash values for each pixel offset, the hash value for each pixel offset can be stored in system memory in, for example, a hash lookup table. Thus, because each pixel offset corresponds to a particular hash value, the hash lookup table only includes a single memory reference (e.g., hash value) per pixel offset. Therefore, when comparing a hash value of a previous frame with a hash value of a current frame, the hash value of the previous frame can be compared against the hash values in the hash lookup table to identify any matches. In one embodiment, to ensure that two distinct blocks of pixels are not represented by the same hash value, once a match occurs, a full block comparison of the matching blocks may be performed to validate against hash collisions to confirm that the block of pixels in the current frame and the previous frame actually match and are not distinct.

FIG. 2 shows an exemplary method 200 for compressing a video requested by web client 164. More specifically, the video is compressed by a server (e.g., web server 162) located within host 110 (shown in FIG. 1) using image block matching that utilizes a full screen exact block search and the compressed video is transmitted to web client 164 located within remote terminal 160 (shown in FIG. 1). This method may be embodied within a plurality of computer-executable instructions stored in one or more memories, such as one or more computer-readable storage mediums. Computer storage mediums may include non-transitory and include volatile and nonvolatile, removable and non-removable mediums implemented in any method or technology for storage of information such as computer-readable instructions, data structures, program modules or other data. The instructions may be executed by one or more processors to perform the functions described herein.

In operation 201, web client 164 establishes one or more communication channels with web server 162, wherein the channel(s) facilitate communication between web client 164 and web server 162. More specifically, in operation 202, web client 164 transmits a request for a video, e.g., in accordance with the processing of a retrieved HTML document. In operation 203, the request for the video is received by web server 162. However, prior to sending the video to web client 164, the video is compressed by web server 162 using image block matching that utilizes a full screen exact block search. Thus, in operation 204, web server 162 initiates a compression process by accessing a reference frame (e.g., a previous frame) of an image in the video. Video may be derived from contents and updates to a frame buffer that stores a GUI for a desktop at the host, however, this video serving technique can be applied in other contexts. In operation 206, web server 162 separates the reference frame into a plurality of reference blocks of pixels. As explained above, the dimensions of a block of pixels may be a power of two (e.g., 2, 4, 8, 16, 32) for each dimension. In one embodiment, a 16 pixel by 16 pixel block is associated with a particular pixel offset. The block of pixels may be defined as including pixels to the right and below the pixel offset (as shown by way of example in Table 1).

In operation 208, web server 162 calculates a hash value for each of the plurality of reference blocks of pixels using a hash function. For example, a value of each pixel within the reference block of pixels may be used in the hash function to calculate a hash value for a corresponding pixel offset. In one embodiment, a summed area table, also referred to as an integral image, may be used at each pixel offset in the reference frame to calculate sums of pixels within a corresponding reference block of pixels. For example, for an image with a pixel (x,y), the corresponding pixel in the integral image is equal to the sum of all pixels above (or below) and to the left (or right) of it. The integral image can be computed in a single pass through the image. It then allows the fast evaluation of the integral of any rectangle in the image by accessing and summing or differencing only four pixels. The sum value from the calculated sum is then used as the hashing function to calculate hash values for each of the reference blocks of pixels. The amount of memory required to execute this approach can be found by multiplying the number of pixels in a frame (e.g., the dimension of the frame) by 4 (4 being the number of pixels needed for accessing and summing or differencing for evaluation of the integral). Thus, with a 1280 pixel by 1024 pixel frame, this approach only requires ((1280×1024)×4) of memory operations to calculate the hash values at each pixel offset. In one embodiment, to further reduce latency, computation time, and memory requirements, a wrapping summed area table may also be used.

In operation 210, the current frame of the video is received by web server 162. The current frame is then separated into a plurality of current blocks of pixels in operation 212, such as, for example, into 16 pixels by 16 pixels blocks. In operation 214, a hash value for each of the plurality of the current blocks of pixels is calculated by web server 162. These hash values can be stored in a hash lookup table in the system memory (not shown). Thus, because each pixel offset corresponds to a particular hash value, the hash lookup table only includes a single memory reference (e.g., hash value) per pixel offset. In operation 216, web server 162 compares the hash values associated with the reference frame with the hash values associated with the current frame. Web server 162 identifies hash values in the reference frame that match hash values in the current frame in operation 218. In one embodiment, to ensure that two distinct blocks of pixels are not represented by the same hash value, once a match occurs, web server 162 executes a full block comparison of the matching blocks to validate against hash collisions. This confirms that the block of pixels in the current frame and the previous frame actually match and are not distinct.

In operation 220, web server 162 stores information indicating that the hash value in the reference frame matches the hash value in the current frame. In one embodiment, the stored information includes vector data relating to an offset in time and distance between the reference block of pixels and a current block of pixels corresponding to the matching hash value. After all matches have been identified and the video is compressed according to known video compression algorithms such as H.264, the compressed video is sent to web client 164, which decompresses the video in operation 223. To decompress the video, web client 164 may use, for example, the same algorithm (e.g., codec) described above with respect to compressing the video. Thus, web client 164 is enabled to decompress the video using a standard codec readily available at remote terminal 160.

The various embodiments described herein may employ various computer-implemented operations involving data stored in computer systems. For example, these operations may require physical manipulation of physical quantities—usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer readable media. The term computer readable medium refers to any data storage device that can store data which can thereafter be input to a computer system—computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

In addition, as mentioned above, one or more embodiments of the present invention may also be provided with a virtualization infrastructure. While virtualization methods may assume that virtual machines present interfaces consistent with a particular hardware system, virtualization methods may also be used in conjunction with virtualizations that do not correspond directly to any particular hardware system. Virtualization systems in accordance with various embodiments, implemented as hosted embodiments, non-hosted embodiments or as embodiments that tend to blur distinctions between the two, are all envisioned. Furthermore, various virtualization operations may be wholly or partially implemented in hardware, or implemented with traditional virtualization or paravirtualization techniques. Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claims(s).

What is claimed is:

1. A system comprising a server for communicating with a client, the server being configured to:
access a reference frame of an image in a video;
separate the reference frame into a plurality of reference blocks of pixels;
calculate, using a hash function, a hash value for each of the plurality of reference blocks of pixels;
receive a current frame of an image in the video;
separate the current frame into a plurality of current blocks of pixels;
calculate, using the hash function, a hash value for each of the plurality of current blocks of pixels;
compare the hash values associated with the reference frame with the hash values associated with the current frame;
identify a hash value in the reference frame that matches a hash value in the current frame; and
store information indicating that the hash value in the reference frame matches the hash value in the current frame for matching blocks of pixels.

2. The system of claim 1, wherein the information includes a motion vector to represent an offset in time and distance between the reference block of pixels and a current block of pixels corresponding to the matching hash value.

3. The system of claim 1, wherein each reference block of pixels is associated with a different pixel offset.

4. The system of claim 3, wherein a value of each pixel within a reference block of pixels is used in the hash function to calculate a hash value for a corresponding pixel offset.

5. The system of claim 1, wherein the calculation of the hash values comprises:
using a summed area table at each pixel offset in the reference frame to calculate sums of pixels within a corresponding reference block of pixels; and
using a sum value from the calculated sums as the hashing function to calculate hash values for each of the reference blocks of pixels.

6. The system of claim 1, wherein dimensions of a block of pixels are a power of two for each dimension.

7. The system of claim 1, further comprising a plurality of processors, and wherein the plurality of processors are programmed to calculate, in parallel, hash values for some number of the plurality of reference blocks.

8. A method for image block matching, the method comprising:
accessing a reference frame of an image in a video;
separating the reference frame into a plurality of reference blocks of pixels;
calculating, using a hash function, a hash value for each of the plurality of reference blocks of pixels;
receiving a current frame of an image in the video;
separating the current frame into a plurality of current blocks of pixels;
calculating, using the hash function, a hash value for each of the plurality of current blocks of pixels;
comparing the hash values associated with the reference frame with the hash values associated with the current frame;
identifying a hash value in the reference frame that matches a hash value in the current frame; and
storing information indicating that the hash value in the reference frame matches the hash value in the current frame for matching blocks of pixels.

9. The method of claim 8, wherein the information includes a motion vector to represent an offset in time and distance between the reference block of pixels and a current block of pixels corresponding to the matching hash value.

10. The method of claim 8, wherein each reference block of pixels is associated with a different pixel offset.

11. The method of claim 10, wherein a value of each pixel within a reference block of pixels is used in the hash function to calculate a hash value for a corresponding pixel offset.

12. The method of claim 8, wherein the calculating of the hash value comprises:
using a summed area table at each pixel offset in the reference frame to calculate sums of pixels within a corresponding reference block of pixels; and
using a sum value from the calculated sums as the hashing function to calculate hash values for each of the reference blocks of pixels.

13. The method of claim 8, wherein dimensions of a block of pixels are a power of two for each dimension.

14. The method of claim 8, wherein the hash values for some number of the plurality of reference blocks are calculated in parallel by a plurality of processors.

15. At least one computer-readable storage medium having computer-executable instructions embodied thereon, wherein, when executed by at least one processor, the computer-executable instructions cause the at least one processor to:
access a reference frame of an image in a video;
separate the reference frame into a plurality of reference blocks of pixels;
calculate, using a hash function, a hash value for each of the plurality of reference blocks of pixels;
receive a current frame of an image in the video;
separate the current frame into a plurality of current blocks of pixels;
calculate, using the hash function, a hash value for each of the plurality of current blocks of pixels;
compare the hash values associated with the reference frame with the hash values associated with the current frame;
identify a hash value in the reference frame that matches a hash value in the current frame; and
store information indicating that the hash value in the reference frame matches the hash value in the current frame for matching blocks of pixels.

16. The at least one computer-readable storage medium of claim 15, wherein the information includes a motion vector to represent an offset in time and distance between the reference block of pixels and a current block of pixels corresponding to the matching hash value.

17. The at least one computer-readable storage medium of claim 15, wherein each reference block of pixels is associated with a different pixel offset.

18. The at least one computer-readable storage medium of claim 17, wherein a value of each pixel within a reference block of pixels is used in the hash function to calculate a hash value for a corresponding pixel offset.

19. The at least one computer-readable storage medium of claim 15, wherein the calculation of the hash value comprises:
using a summed area table at each pixel offset in the reference frame to calculate sums of pixels within a corresponding reference block of pixels; and
using a sum value from the calculated sums as the hashing function to calculate hash values for each of the reference blocks of pixels.

20. The at least one computer-readable storage medium of claim 15, wherein dimensions of a block of pixels are a power of two for each dimension.
